(19) United States
(12) Patent Application Publication
(10) Pub. No.: US 2002/0138607 A1
(43) Pub. Date: Sep. 26, 2002

(54) System, method and computer program product for data mining in a three-dimensional multi-user environment

(75) Inventors: Kristen P. O' Rourke, Menlo Park, CA (US); Douglas S. Banks, Menlo Park, CA (US); Jason G. McHugh, Menlo Park, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: THERE

(21) Appl. No.: 09/814,124

(22) Filed: Mar. 22, 2001

(51) Int. Cl. G06F 15/173; G06F 15/16

(52) U.S. Cl. 709/224; 709/218

(57) ABSTRACT

A data mining system, method and computer program product is provided for tracking user behavior in a three-dimensional (3D) multi-user environment. The system includes server side components that simulate the 3D multi-user environment and objects therein, and a plurality of clients connected to the server side components via a network. The server side components maintain data mining pylons that generate data mining facts concerning the location of objects in the 3D multi-user environment, as well as objects with usage triggers that detect when an avatar interacts with an object and generate a data mining fact in response. The server side components data also generate data mining facts related to user login and registration, commerce, communication, world and object state, user relationships, surveys, advertising, and customer-submitted content. Data mining facts are stored in one or more data warehousing files and may be analyzed to discover, predict or confirm trends in user behavior and preferences. The data warehousing files may also be linked to external data mining information generated by other real-world systems and commercial entities.

### BACKGROUND OF THE INVENTION

1. Field of the Invention

The present invention is related to data mining systems, methods and computer program products. In particular, the present invention is related to systems, methods and computer program products for data mining in three-dimensional multi-user environments.

2. Background

Data mining refers to a variety of techniques for capturing data pertaining to customer behavior and preferences. In a conventional data mining system, real-time or historical information pertaining to a series of customer activities or transactions is extracted and stored. This information may then be analyzed to discover or predict trends in customer behavior and preferences, as well as to prove or disprove previous assertions and beliefs concerning trends in customer behavior and preferences. Conventional data mining techniques seek to provide as much information as possible about each customer on an individual basis, thereby enhancing the depth and accuracy of analyses based on mined data.

Conventional data mining systems are disadvantageous, however, in that they cannot provide a complete picture of a customer's behaviors and preferences. For example, in a supermarket, customer shopping behavior may be recorded by sensors and/or surveillance cameras to determine how customers move through the supermarket, where they spend their time, and what items or displays most arouse their interest. Additionally, a scanner may be used at the check-out counter to identify items purchased by a customer and map those purchases to a customer account. However, such a data mining system cannot provide a complete picture of a customer's behavior, because the customer's shopping behavior as recorded by the camera or sensor cannot be linked to the purchase information recorded during check-out.

Conventional data mining systems are also disadvantageous in that they provide only a very limited amount of information about a customer. For example, tracking customer activity on an Internet Web site will usually provide only a nominal amount of data about a given customer. This is due, in part, to the fact that a customer can only engage in a limited number of activities on an Internet Web-site, which typically consists of a two-dimensional (2D) graphical user interface (GUI). For instance, the customer may only be permitted to click on a button or submit a text message. As a result, data mining of Web site activity will normally result in only a small amount of information related to a series of isolated events.

In contrast, a customer's activities in a three-dimensional (3D) multi-user environment provide a massively rich source of information for data mining purposes. In a 3D multi-user environment, computer users interact with digital representations of each other, sometimes called “avatars,” and other objects in a commonly-shared virtual 3D space. In commercial 3D multi-user environments, a customer may assume the identity of an avatar and participate in a variety of activities, including shopping, purchasing, game-playing, and social interaction, often in return for on-line payments and/or a monthly fee. Such systems are therefore capable of providing an abundance of customer-specific data relating to each of the many different user activities. Moreover, because a 3D multi-user environment can essentially simulate every customer behavior—for example, browsing as well as purchasing—these systems can provide a complete picture of a customer's behavior for data mining purposes.

However, it has been observed that traditional data mining methods are insufficient for tracking a customer's behavior in a 3D multi-user environment. New mechanisms are necessary to collect customer data that are specific to a 3D virtual world. For example, new approaches are required to determine where and when to record a given customer activity in the virtual world and for determining which part of the system is responsible for recording the action. These and other issues related to data mining in a 3D multi-user environment are addressed by the present invention.

### BRIEF SUMMARY OF THE INVENTION

The present invention is directed to a data mining system, method and computer program product for tracking user behavior in a three-dimensional multi-user environment.

In an embodiment of the present invention, the system includes an Ihost server and a plurality of clients connected to the Ihost server via a network. The Ihost server simulates the three-dimensional multi-user environment and objects therein, and also maintains a data mining pylon in the three-dimensional multi-user environment. Each of the clients allows a user to alter the location of objects in the three-dimensional multi-user environment. The data mining pylon generates a data mining fact concerning the location of objects in the three-dimensional multi-user environment.

In a further embodiment of the invention, one of the plurality of clients further comprises an editor. The editor allows a user or an employee to create a data mining pylon and change the state of a data mining pylon in the three-dimensional multi-user environment.

In an alternate embodiment of the present invention, the Ihost server simulates the three-dimensional multi-user environment and objects therein, wherein a portion of the objects include avatars. Each of the clients allows a user to control one of the avatars to interact with another one of the objects in the three-dimensional multi-user environment. The Ihost server further comprises an object that detects when an avatar interacts with an object and generates a data mining fact in response to the interaction.

In another alternate embodiment of the present invention, the data mining system also includes an AvMan server connected to the Ihost server, wherein the AvMan server includes a data warehousing file. The Ihost server provides the data mining fact to the AvMan server and the AvMan server receives the data mining fact and stores it in the data warehousing file. In further embodiments, the AvMan server generates a second data mining fact and stores the second data mining fact in the data warehousing file, wherein the second data mining fact includes at least one of the following types of information: user login information; user registration information; commerce information; communication information; world state information; object state information; user relationship information; survey information; advertising information; customer-submitted content information; Web activity information; or user interface events information.

The invention is advantageous in that it provides for the data mining of information pertaining to significant events, attributes, relationships and state changes in a 3D multi-user environment in which many customer behaviors are simulated.

The invention is also advantageous in that it provides a data mining system, method and computer program product for a 3D multi-user environment that is flexible and configurable to capture desired information at predetermined times in a virtual 3D world. For example, the invention is configurable to capture information relating to avatar interaction with objects, as well as avatar movement and location. The invention is further configurable to capture information relating to events as they happen or to poll for information at specific times and frequencies.

The invention is further advantageous in that it provides a data mining system, method and computer program product for a 3D multi-user environment that captures and stores information pertaining to user login and registration, electronic commerce, communication, world and object state, user relationships, surveys, advertising, customer-submitted content, Web activity, and user interface events.

Another advantage of the invention is that it provides a data mining system, method and computer program product for a 3D multi-user environment in which the data mining functions are centrally administered.

Yet another advantage of the invention is that it provides a data mining system, method and computer program product for a 3D multi-user environment that operates to conserve system resources.

Another benefit of the invention is that it provides for the data mining of information in a 3D multi-user environment that may be used to discover, predict and confirm trends in customer behavior and to deliver targeted content to users.

The invention is also beneficial in that it provides for the extraction and storing of data mining information in a format that retains key relationships.

A further benefit of the invention is that it provides for the extraction and storing of data mining information in a format that is relatable to external, real world information.

Additional features and advantages of the invention will be set forth in the description that follows, and in part will be apparent from the description, or may be learned by practice of the invention. The objectives and other advantages of the invention will be realized and attained by the system and method particularly pointed out in the written description and claims hereof as well as the appended drawings.

### BRIEF DESCRIPTION OF THE DRAWINGS/FIGURES

The accompanying drawings are included to provide a further understanding of the invention and are incorporated in and constitute part of this specification. The drawings illustrate the preferred embodiment of the invention and together with the description serve to explain the principles of the invention.

FIG. 1 is a block diagram of a 3D multi-user system according to an embodiment of the present invention.

FIG. 2 depicts an Ihost server and an AvMan server in a 3D multi-user system in accordance with an embodiment of the present invention.

FIG. 3 is a block diagram of a 3D multi-user system in accordance with an embodiment of the present invention.

FIG. 4 is an example client graphical user interface in a 3D multi-user system in accordance with an embodiment of the present invention.

FIG. 5 is an alternate example client graphical user interface in a 3D multi-user system in accordance with embodiments of the present invention.

FIGS. 6-9 depict a 3D viewport that provides various views of a 3D multi-user environment in accordance with an embodiment of the present invention.

FIG. 10 depicts a first and a second AvMan server in a 3D multi-user system in accordance with an embodiment of the present invention.

The present invention will now be described with reference to the accompanying drawings. In the drawings, like reference numbers indicate identical or functionally similar elements. Additionally, the left most digit(s) of a reference number identifies the drawing in which the reference number first appears. Although several preferred embodiments of the present invention are particularly shown and described below, one skilled in the art will appreciate that various changes in forms and details may be made without departing from the spirit and scope of the invention as defined in the appended claims.

### DETAILED DESCRIPTION OF THE INVENTION

### Table of Contents

A. Overview of the Invention

B. 3D Multi-User System in Accordance with Embodiments of the Present Invention

C. Data Mining in a 3D Multi-User Environment in Accordance with Embodiments of the Present Invention

1. Data Mining on the Ihost Server

a. Objects with Usage Triggers

b. Data Mining Pylons

i. Introducing and Maintaining Data Mining Pylons

ii. Capturing Pylon Data

2. Data Mining on the AvMan Server

D. Data Warehousing in Accordance with Embodiments of the Present Invention

E. Conclusion

A. Overview of the Invention

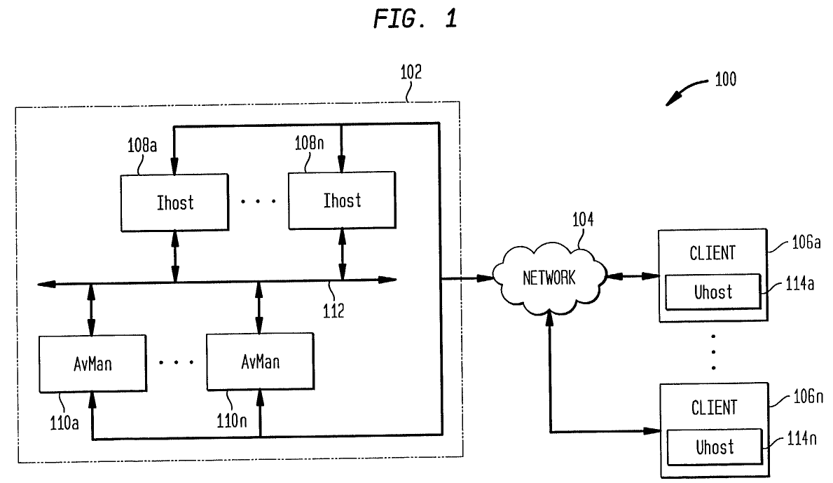

The present invention is directed to a system, method and computer program product for data mining in a 3D multi-user environment. The invention will now be further described in reference to FIGS. 1-10.

B. 3D Multi-User System in Accordance with Embodiments of the Present Invention

FIG. 1 is a high-level block diagram of an example 3D multi-user system 100 with data mining capabilities in accordance with the present invention. It should be understood that the example 3D multi-user system 100 is shown for illustrative purposes only and does not limit the invention. Other implementations of the 3D multi-user system described herein will be apparent to persons skilled in the relevant art(s) based on the teachings contained herein, and the invention is directed to such other implementations.

Referring to FIG. 1, the example 3D multi-user system 100 includes a server cluster 102, a plurality of clients 106a-106n, and a network 104. The server cluster 102 represents server side components of the 3D multi-user system 100 while the clients 106a-106n represent client side components of the 3D multi-user system 100.

Network 104 connects the server side and client side components of the present invention and facilitates the exchange of information between these components. Network 104 can be any type of computer network or combination of networks including, but not limited to, circuit switched and/or packet switched networks. In one embodiment, network 104 includes the Internet.

Any conventional communication protocol can be used to support communication between the components of the 3D multi-user system 100. For example, a UDP/IP or TCP/IP suite can be used to establish links and transport data. A World Wide Web-based application layer and browser (and Web server) can also be used to further facilitate communication between the components shown in FIG. 1. However, these examples are illustrative. The present invention is not intended to be limited to a specific communication protocol or application, and other proprietary or non-proprietary network communication protocols and applications can be used.

The server cluster 102 simulates and administers a 3D multi-user environment and exchanges information with clients 106a through 106n via network 104 to permit users to interact in a commonly-shared virtual 3D world. Although only one server cluster 102 is shown for clarity, in general any number of server clusters can be included in the 3D multi-user system of the present invention.

The server cluster 102 includes a plurality of Ihost servers 108a through 108n and a plurality of AvMan servers 110a through 110n. In embodiments, the server cluster 102 is comprised of 2000 Ihost servers 108 and 200 AvMan servers 110. However, the invention is not so limited and persons skilled in the art will appreciate that any number of Ihost servers 108 or AvMan servers 110 may be used.

The Ihost servers 108a-108n and the AvMan servers 110a-110n are each operably connected to each other via a network connection 112. The network connection 112 can include one or more computer buses for connecting components co-existing on the same network server, as well as any other type of communication infrastructure for connecting remote components including, but not limited to, circuit switched and/or packet switched networks, as well as wireless networks. In embodiments, the network connecting the components within the server cluster 102 includes a local area network (LAN).

In an embodiment, each Ihost server 108a-108n and AvMan server 110a-110n comprises a separate software component running on a dedicated network server. In alternate embodiments, multiple Ihost servers and/or AvMan servers may run on the same network server. In a further alternate embodiment, all the Ihost and AvMan servers run on a single very powerful network server.

Each Ihost server 108a-108n simulates a fixed geographic region of the overall 3D virtual world. Accordingly, each Ihost server 108a-108n is responsible for simulating a physics model that governs the motion and interaction of distributed objects and for distributing this information to all client machines and to all neighboring Ihost servers. Distributed objects include avatars, which are digital representations of each user in the 3D multi-user environment, as well as all of the objects which the user may view and with which the user may interact. In an embodiment of the present invention, the server cluster 102 can support up to 10 million distributed objects.

Each Ihost server 108a-108n is responsible for managing a plurality of server objects, which are single authoritative instances of a distributed object. Non-authoritative versions of the same distributed objects also exist on one or more clients and Ihost servers. Non-authoritative versions of objects are identical to authoritative objects in that they receive user input, can be manipulated and run physics. However, unlike server objects, non-authoritative objects must “check” important state changes with the single authoritative instance. The management of server objects, or unique authoritative versions of distributed objects, on the server side of the 3D multi-user system 100 ensures the integrity and consistency of the state and appearance of each distributed object across all the components of the server cluster 102 and all the client machines 106a through 106n. Thus, the Ihost servers 108a-108n provide centralized administration of the distributed objects rendered in the virtual 3D world.

In an embodiment of the present invention, each Ihost server 108a-108n manages apredetermined portion of the total number of overall server objects that are maintained on the server cluster 102. The number of server objects managed by each Ihost server is determined according to an algorithm such that a unique server object exists on only one Ihost server, with some Ihost servers maintaining non-authoritative (or “shadow”) versions of that object. In embodiments, the algorithm may include a load balancing algorithm that can dynamically move server objects from one Ihost server to another in order to ensure that the processing capacity of any given Ihost server is not exceeded as objects move around.

The AvMan servers 110a through 110n generally perform all the functions of running the 3D multi-user environment apart from the simulation of the virtual 3D world. In part, the AvMan servers 110a-110n maintain a database that stores information relating to the state of each of the distributed objects in the virtual 3D world. For example, the AvMan servers 110a-110n maintain a database that stores the location of each distributed object in the 3D multi-user environment. The AvMan servers 110a-110n also perform such administrative functions as managing user registration and login, user relationships, electronic commerce, user communication (for example, e-mail, instant messaging and chat), advertising, and customer-submitted content.

The clients 106a through 106n are operated by users to access the commonly-shared 3D multi-user environment simulated and administered by the server cluster 102 and to interact therein. For example, the clients 106a-106n can be used to interact with and move distributed objects in the 3D virtual world. In embodiments, each client 106a through 106n is a personal computer running proprietary software that interacts with the server cluster 102 over the network 104. In further embodiments, the 3D multi-user system 100 can support the use of up to 100,000 clients simultaneously.

Each of the clients 106a-106n includes a Uhost module 114a-114n, respectively, that simulates a 3D multi-user environment that is consistent with the simulation run by the Ihost servers 108a-108n on the server side of the 3D multi-user system 100. However, unlike the Ihost servers 108a-108n, the Uhost modules 114a-114n do not maintain server objects and, thus, cannot authoritatively change the state of distributed objects in the 3D multi-user environment. For example, when the user of client 106a interacts with a distributed object and thereby changes its state, amessage is sent from client 106a to the Ihost server that maintains the server object corresponding to the distributed object. In response to the message, the Ihost server authoritatively changes the state of the server object, such that all of the clients 106a-106n and the remaining Ihost servers will then receive consistent information about the updated state of the object and revise their own simulations accordingly. However, the Ihost servers do not provide for persistent storage of information regarding object state. Accordingly, the AvMan servers 110a110n maintain databases containing information about the state of distributed objects. These databases are updated periodically by the Ihost servers.

The datamining capabilities of the 3D multi-user system 100 in accordance with the present invention will now be described.

C. Data Mining in a 3D Multi-User Environment in Accordance with the Present Invention

Data mining in a 3D multi-user environment in accordance with embodiments of the present invention involves the generation of data mining “facts” by the Ihost servers 108a-108n and/or the AvMan server 110a-110n during the ongoing simulation and administration of the 3D multi-user environment. The term “fact,” as used herein, generally describes one or more data structures that contain information relating to the simulation or administration of the 3D multi-user environment. Data mining facts are collected on both the Ihost servers 108a-108n and the AvMan servers 110a-110n and are ultimately stored in one or more data warehouse (DW) files on the AvMan servers 110a-110n.

In embodiments of the present invention, fact generation functionality is allocated to server-side components as opposed to client-side components for a number of reasons. Requiring clients to generate and transmit facts to the server-side components would utilize limited bandwidth that might otherwise be used to ensure the quality and consistency of the simulation. Furthermore, allowing the clients to generate facts would require the installation of mechanisms to guard against the submission of unauthorized or erroneous facts by client users. Finally, permitting server-side components to generate facts simplifies matters by entrusting the accounting of events and state information to a centralized authoritative entity. For example, where objects are responsible for generating facts, allocating the fact-generation responsibility to authoritative server objects will ensure that only a single fact is generated per object event, even though multiple instances of the same object may appear on many machines. Yet another benefit of allocating fact generation functionality to a centralized server cluster is that fact generation may be controlled or altered without requiring modification of multiple copies of client software.

1. Data Mining on the Ihost Server

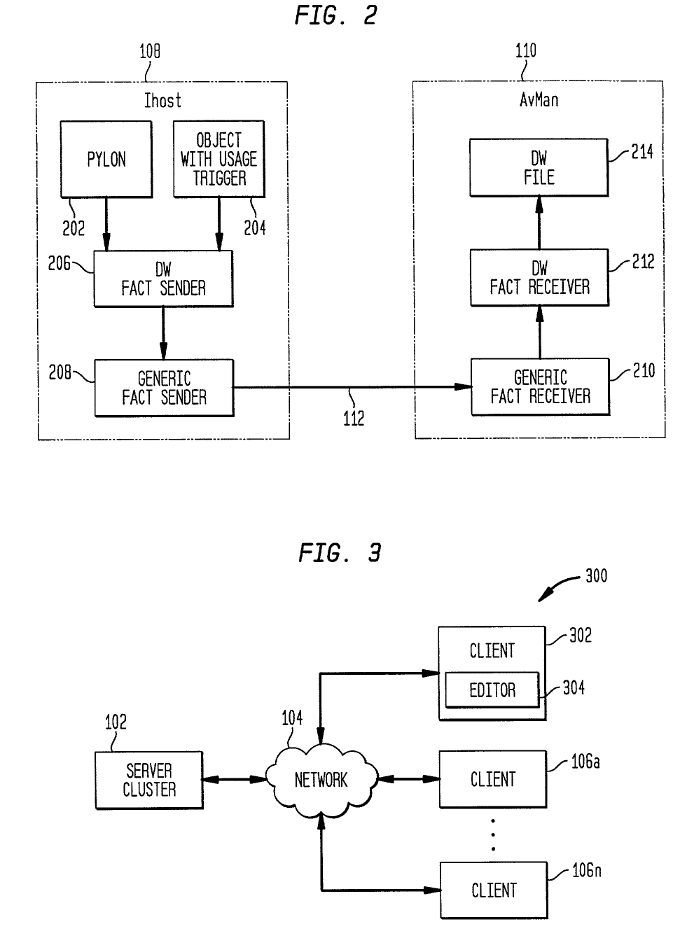

FIG. 2 presents a more detailed depiction of a single Ihost server 108 and a single AvMan server 110 within the server cluster 102 described above in regard to FIG. 1. As discussed in more detail above, the Ihost server 108 and the AvMan server 110 are operably interconnected via the network connection 112.

The Ihost server 108 includes a pylon 202, an object with usage trigger 204, a DW (data warehousing) factSender 206, and a generic factSender 208. The AvMan server 110 includes a generic factReceiver 210, a DW factReceiver 212, and a DW file 214. The terms “factSender” and a “factReceiver” refer to code-based services that transmit and receive facts, respectively, that have been generated by other components of the system.

During the ongoing simulation of the 3D multi-user environment by the Ihost 108, the pylon 202 and/or the object with usage trigger 204 generate data mining facts that are sent to the DW factSender 206. The manner by which data mining facts are generated by the pylon 202 and the object with usage trigger 204 will be discussed in more detail below.

The DW factSender 206 receives the data mining facts, formats them, and sends them to the generic factSender 208, which receives the data mining facts as well as other facts generated within the Ihost server 108. The generic factSender 208 then formats and sends the data mining facts along with the other facts to the AvMan server 110. In an embodiment, the generic factSender 208 sends the facts to the AvMan server 110 as UDP packets using a UDP/IP protocol.

The generic factReceiver 210 receives the facts sent from the generic factSender 208 on the Ihost server 108. The DW factreceiver 212 registers with the generic factReceiver 212 to selectively receive the data mining facts from the larger pool of facts received by the generic factReceiver 210. The DW factReceiver 212 then reformats the data mining facts for placement in a data warehousing file 214.

In embodiments, the Ihost server may contain one or more pylons 202 and no objects with usage triggers 204, one or more objects with usage triggers 204 and no pylons 202, or any combination of pylons 202 and objects with usage triggers 204. In further embodiments, a single factSender and factReceiver may be used to send and receive facts, as opposed to using the DW factSender 206, Generic factSender 208, a generic factReceiver 210 and a DW factReceiver 212, as will be appreciated by persons skilled in the art.

a. Objects with Usage Triggers

Objects with usage triggers 204 comprise logical components within the Ihost server 108 that generate data mining facts when two objects interact within the 3D multi-user environment. When the objects interact, the object with usage trigger 204 will cause the corresponding server object of one or both objects maintained by the Ihost server to generate a data mining fact. For example, an object with usage trigger 204 can generate a data mining fact whenever an avatar interacts with that object in the 3D multi-user environment.

Objects programmed to have usage triggers may be chosen based on their data mining relevancy. For example, if the use of a jetpack object were of interest from a data mining standpoint, a jetpack object with a usage trigger can be created that generates a data mining fact whenever an avatar picks up the jetpack, puts on the jetpack, flies with the jetpack, crashes with the jetpack, or discards the jetpack. Alternately, if facts concerning the use of a paint gun object were sought, a paint gun object with a usage trigger can be created that generates a data mining fact whenever an avatar picks up the paint gun, shoots the paint gun, hits a target with the paint gun, or discards the paint gun.

A data mining fact generated by an object with usage trigger 204 generally includes information pertaining to the object usage event. In embodiments, the data mining fact includes at least the following information: (1) the type of event that has occurred, (2) the identity of the primary object that initiated the event, or the group they belong to (e.g., an avatar), (3) the distributed object with which the primary object interacted, (4) the time the event occurred, and (5) the location in the virtual 3D world where the event occurred. Example event types include entering a data mining pylon, leaving a data mining pylon, getting on a vehicle, getting off a vehicle, crashing a vehicle, picking up an object, dropping an object, taking out an object (from inventory), putting away an object (to inventory), shooting a projectile, hitting an object with a projectile, and using a teleporter. Further information may be included in the data mining fact depending on the type of event that has occurred. For example, if the event is the firing of a projectile by a first avatar at a second avatar, the data mining fact may include an indication of whether the second avatar was hit by the projectile.

Code triggers may be used more generally to record any action by the avatar rather than just those involving object usage. However, as discussed above, the generation of data mining facts is entrusted to server-side components of a 3D multi-user system in accordance with embodiments of the present invention. Where too many facts are generated, server resources necessary for administering and simulating the 3D multi-user environment may be depleted, resulting in a degradation in the quality of the simulation. By limiting triggers to interaction with selected objects or object types, embodiments of the present invention restrict the number of facts generated by the 3D multi-user system and thereby conserve system resources. Additionally, limiting data collection to only key object usage events simplifies the analysis of mined data by screening out extraneous data related to actions that are insignificant from a data mining perspective.

b. Data Mining Pylons

Data mining pylons, such as the data mining pylon 202 of FIG. 2, are distributed objects that define a volume around a single point in the 3D multi-user environment. Data mining pylons may be placed around objects and regions of interest in the 3D multi-user environment in order to track object behavior in relation to those objects and regions of interest. In this way, significant information relating to customer behavior may be captured. For example, data mining pylons may generate data mining facts concerning the location and movement of avatars in relation to other distributed objects and regions in the virtual 3D world. These data mining facts may include information such as which avatars have entered and exited a pylon.

Because a data mining pylon is a specified volume of space, it may take the form of any shape. For example, a data mining pylon may comprise a box, sphere, cylinder, cone or some oddly-shaped object. In embodiments of the present invention, data mining pylons are implemented as simple geometric structures such as boxes, cylinders, spheres, and cones to provide for more efficient collision resolution in determining whether or not an object has entered or exited a pylon.

It has been observed that the use of pylons comprising 3D volumes to track object location and movement in a 3D multi-user environment is substantially more efficient than the use of 2D planes.

For example, in order to determine whether an avatar has crossed a 2D plane, a system must: (1) at a first time, determine which avatars are within a crossing range of the 2D plane as determined by the polling frequency and avatar movement speed and record the location of these avatars in a first list, (2) at a subsequent time, determine which avatars are within crossing range of the 2D plane as determined by the polling frequency and avatar movement speed and record the location of these avatars in a second list, (3) for each avatar in the first and second list, extrapolate a speculative path of motion based on the first location and second location of the avatar, and (4) determine if the speculative path of motion crosses the 2D plane. This method is computationally expensive in terms of system resources.

In contrast, when using data mining pylons comprised of geometric volumes, and disregarding the loss of information present in a polling system, a determination need only be made as to which avatars are within a pylon at discrete points in time. By comparing a list of which avatars were previously in the pylon to a list of which avatars are currently in the pylon, the pylon can determine which avatars have entered and exited the pylon.

Additionally, because a data mining pylon comprises a 3D volume as opposed to a 2D plane, it may be used to simultaneously cover all manners of entry and exit from a given structure within the virtual 3D world, including roof top exits and entrances.

Furthermore, a 3D volume is easier to maintain when changes are made to structures. For example, if an artist decides to alter a building to allow for a rooftop entrance, then the change will not affect the efficacy of the 3D volume for data mining. However, where 2D planes are used, additional 2D planes would be required to cover the same area.

Data mining pylons may be invisible or visible. An invisible object is an object in the virtual 3D world that has not rendered or drawn itself. In embodiments, the default state of data mining pylons is invisible. However, an invisible pylon may be made visible to a system administrator or to all the users of the 3D multi-user environment by modifying the state of the pylon object.

Data mining pylons may be nested within other data mining pylons. Accordingly, a volume of 3D space as well as a subset of that 3D space may be monitored for data mining purposes. This may be useful, for example, where the objects of interest include a virtual shopping mall as well as an individual store within the virtual shopping mall.

In further embodiments, data mining pylons may be attached to moving objects within the 3D multi-user environment, and therefore move with those objects. For example, a data mining pylon may be attached to a train object to track the usage of a particular train. This permits data mining in relation to objects that are not tied to a particular geographic region within the 3D multi-user environment.

i. Introducing and Maintaining Data Mining Pylons

FIG. 3 is a high-level block diagram of an example 3D multi-user system 300 that supports the placement of data mining pylons in accordance with embodiments of the present invention. The 3D multi-user system 300 includes a server cluster 102, a network 104, a client 302, and a plurality of other clients 106a through 106n. The server cluster 102, the network 104, and the clients 106a-106n are each described in more detail in regard to FIG. 1, above.

The client 302 includes an editor 304 that is used by a client user to modify the 3D multi-user environment that is simulated and administered by the server cluster 102. In particular, the editor 304 comprises a 2D graphical user interface (GUI) that permits a user to instantiate new data mining pylons in the 3D multi-user environment and to modify the attributes of existing data mining pylons at any time. In embodiments, the editor 304 further comprises an “in-world” 3D GUI that permits a user to move or resize a data mining pylon by clicking and dragging on the pylon via a viewport into the 3D multi-user environment.

Data pylon attributes that may be modified by the editor 304 include the following:

Pylon name.

Initial pylon placement location: specified using 3D coordinates (implied orientation).

Pylon orientation: specifies offset in degrees from the original direction of the object.

Shape and size: length, width and height for a box; diameter length, diameter width, and diameter height for a sphere; diameter length, diameter width and height for a cylinder; outer ring diameter length and width, inner ring diameter length and width, and distance between rings for a round cone; outer box length, width and height, inner box length, width and height, and distance between boxes for a square cone.

Recording frequency: can be any number such as 0.5 seconds or 1.5 seconds.

When to activate or deactivate.

How long to leave active: may be indefinitely.

Data points collected related to the state of an object within the pylon: may include time at enter, enter coordinates, primary object ID (e.g, avatar ID), pylon ID, location coordinates, objects carried, ridden, or “in use” (may include apparel of avatar), inventory objects not in use, identification of activity that avatar is participating in, time at exit, or exit coordinates.

Data points collected related to actions within the pylon: may include total time of avatar in pylon (time counter), count of other avatars in pylon at enter, count of other avatars in pylon at exit, count of other objects in pylon at enter, count of other objects in pylon at exit, identification of relationships with other avatars, position within pylon, or identification of avatar chat buddy.

The editor 304 converts information provided from a user interface, such as the creation and modification of data mining pylons by a user, into edit messages and transmits the edit messages to an Ihost server within the server cluster 102 to affect a change to the 3D multi-user environment. Edits may be made in real-time while the simulation is running and do not require an interruption of the operation of the server cluster 102 or any of its components.

In embodiments, the edit messages sent from the editor 304 to the Ihost server are Extensible Markup Language (“XML”) documents.

For example, the user may interact with a GUI of the editor 304 to create a data mining pylon in the 3D multi-user environment. As a result, the editor 304 transmits an edit message to an Ihost server within the server cluster 102. In response to the edit message, the Ihost server creates a new server object that corresponds to the new data mining pylon created by the user. Shadow copies of the new server object may then be created on Ihost servers simulating nearby geographic regions of the virtual world and on the clients 106a-106n.

Alternately, the user may interact with a GUI of the editor 304 to modify the attributes of a data mining pylon in the 3D multi-user environment. As a result, the editor 304 transmits an edit message to an Ihost server within the server cluster 102. In response to the edit message, the Ihost server alters the attributes of the server object corresponding to the data mining pylon in the same manner. Shadow copies of the data mining pylon existing on other Ihost servers and on the clients 106a-106n will then be updated in accordance with the change.

The user of the editor 304 will typically be a system administrator or employee of a company responsible for creating and running the 3D multi-user environment. However, the editor 304 may also be used by an actual participant in the 3D multi-user environment. For example, the editor 304 may be used by a participant who has been granted special privileges. In such a scenario, the editor 304 is run on the same client machine that is running the client-side simulation of the 3D multi-user environment. Thus, in regard to FIG.3, the editor 304 may be run on any of the client machines 106a-106n.

In further embodiments, there may be many instances of client 302 or many clients 106a-106n that each include the editor 304. The editor 304 may also be limited to certain clients, although the set of clients that can use it is dynamic.

In embodiments, the Ihost server can determine if a requested edit is authorized or unauthorized, and reject edits that it determines are unauthorized. In this way, the Ihost server can discriminate between desired changes entered by users such as system administrators, employees, or participants with special privileges and undesired changes entered by users seeking to make unauthorized changes to the virtual 3D world.

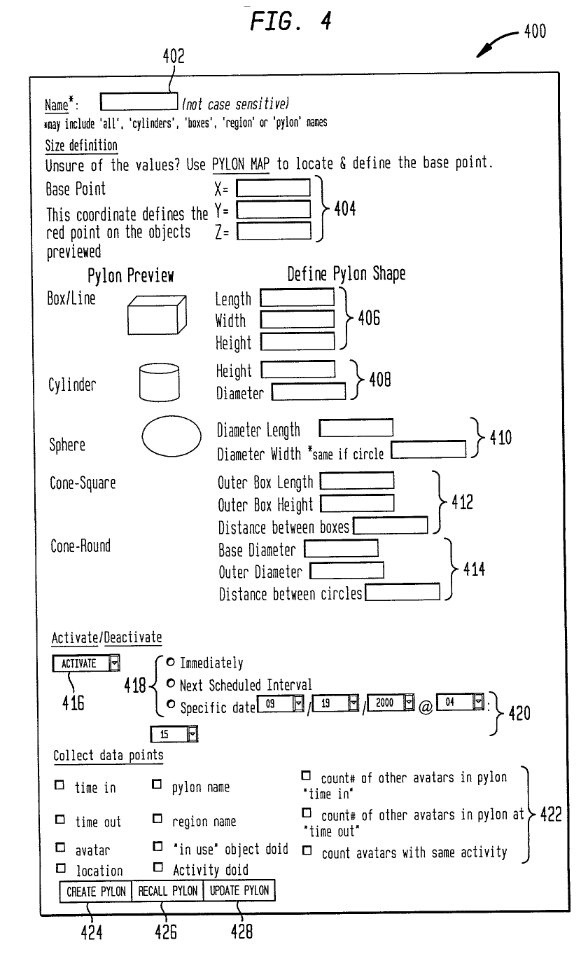

FIG. 4 depicts an example graphical user interface (GUI) 400 of the editor 304 that permits a user to create and configure pylons within the 3D multi-user environment. The GUI 400 includes a plurality of command buttons, text boxes, check boxes, option buttons, and drop-down list boxes that permit the user to input data concerning the creation and configuration of a data pylon, each of which will be described below.

The Name text box 402 permits the user to input a name for a new or existing data pylon. By typing an existing pylon name into the Name text box 402 and clicking on the Recall Pylon command box 426, the parameters for an existing data pylon will be called up and displayed by the GUI 400. Alternately, a predefined group name may used to recall all pylons of a certain type. Such predefined group names may include, for example, “ALL,” to recall all pylons, “CYLINDERS,” to recall all cylinder-shaped pylons, “BOXES,” to recall all box-shaped pylons, or a specific region name, to recall all the pylons from a given region of the 3D multi-user environment.

Alternately, the Name text box 402 may be used in conjunction with the Create Pylon command button 424 to input a name for a newly-created data pylon.

The X, Y and Z text boxes 404 are used to input the position of the base point of a pylon in the 3D multi-user environment when creating, editing or recalling a pylon.

The Length, Width and Height text boxes 406 are used to define a box-shaped data pylon in the 3D multi-user environment. The Length, Width and Height text boxes 406 are used to input the length, width and height of the box-shaped pylon, respectively.

The Height and Diameter text boxes 408 are used to define a cylinder-shaped data pylon in the 3D multi-user environment. The Height and Diameter text boxes 408 are used to input the height and diameter of the cylinder-shaped pylon, respectively.

The Diameter Length and Diameter Width text boxes 410 are used to define a sphere-shaped data pylon in the 3D multi-user environment. The Diameter Length and Diameter Width text boxes 410 are used to input the diameter length and diameter width of the sphere-shaped pylon respectively. An equal diameter length and diameter width will result in a data pylon that is a perfect sphere (in other words, the data pylon will be composed of perfect circles).

The Outer Box Length, Outer Box Height, and Distance Between Boxes text boxes 412 are used to define a cone-shaped data pylon in the 3D multi-user environment in which the cone is composed of squares. The Outer Box Length, Outer Box Height, and Distance Between Boxes text boxes 412 are used to input the outer box length, outer box height and distance between boxes for the cone-shaped data pylon, respectively.

The Base Diameter, Outer Diameter, and Distance Between Circles text boxes 414 are used to define a cone-shaped data pylon in the 3D multi-user environment in which the cone is composed of circles. The Base Diameter, Outer Diameter, and Distance Between Circles text boxes 414 are used to input the base diameter, outer diameter and distance between circles for the cone-shaped data pylon, respectively.

The Activate/Deactivate drop-down list box 416, along with the option buttons 418 and the date and time drop-down list boxes 420, permit a user to select a time at which the polling of the data pylon will start or stop. In embodiments of the present invention, data pylons may be polled at predetermined intervals, or when a specific event occurs in the 3D multi-user environment, such as when an avatar enters or exits a data pylon

Where the Activate/Deactivate drop-down list box 416 is used to select “ACTIVATE,” the option buttons 418 and time drop-down list boxes 420 may be used to select a time when the polling of a data pylon will begin. When the Activate/Deactivate drop-down list box 416 is used to select “DEACTIVATE,” the option buttons 418 and time drop-down list boxes 420 may be used to select a time when the polling of the data pylon will stop. The option buttons 418 permit a user to start or stop polling immediately, at the next scheduled polling interval, or at a specific date or time as specified via the date and time drop-down list boxes 420.

The check boxes 422 are used to select the information that will be included in the data mining fact generated when a data pylon is polled. The following is a list of each check box and a description of the corresponding item of information that will be included when the check box is checked:

Time In: the time that an avatar enters the pylon.

Time Out: the time that an avatar leaves the pylon.

Avatar: an identification of the avatar that has entered or exited the pylon.

Location: the precise location of the avatar.

Pylon Name: the name of the pylon.

Region Name: the name of the region in the 3D multi-user environment where the pylon is located.

“In Use” Object Doid: an indication of which object(s), if any, the avatar is currently using.

Activity Doid: an indication of which system-recognized activity, if any, the avatar is currently participating in.

Count # of other Avatars in Pylon “Time In”: the total number of other avatars in the pylon at the time the avatar entered the pylon.

Count # of other Avatars in Pylon “Time Out”: the total number of other avatars in the pylon at the time the avatar exited the pylon.

Count Avatars with Same Activity: the total number of other avatars in the pylon who are participating in the same system-recognized activity, if any, that the avatar is currently participating in.

“Inventory” Object Doids: an indication of all the objects currently being carried by the avatar, but not in use.

The Create Pylon command button 424, the Recall Pylon command button 426 and the Update Pylon command button 428 are used to create, recall and update data pylons, respectively. In particular, the Create Pylon command button 424 is used to create a new data pylon. The Recall Pylon command button 426 may be clicked on by the user to recall the data pylon or pylons indicated by the text in the Name text box 402 or by the coordinates in the X, Y and Z text boxes 404. The Update Pylon command button 428 is used to change the configuration of the existing data pylon whose parameters are displayed in the GUI 400.

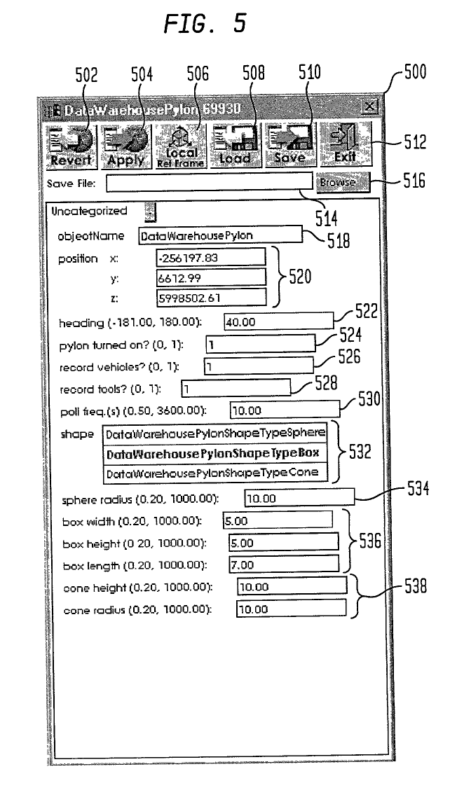

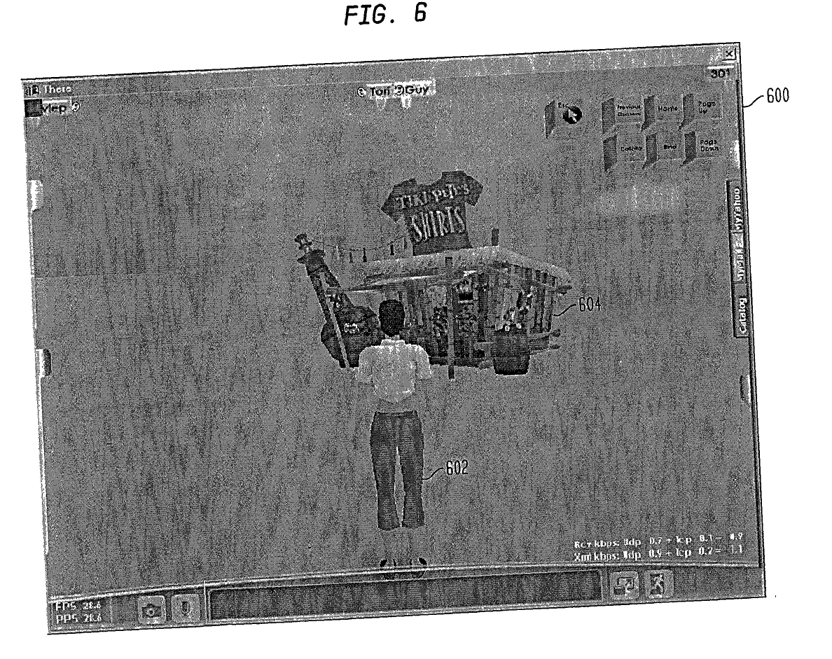

FIG. 5 depicts an alternative graphical user interface (GUI) 500 of the editor 304 that permits a user to create and configure pylons within the 3D multi-user environment. The GUI 500 includes a plurality of command buttons, text boxes, and list boxes that permit a user to input data concerning the creation and configuration of a data pylon, each of which will be described below.

The Revert command button 502 is used to undo an edit that has been made to a data mining pylon.

The Apply command button 504 is used to apply an edit that has been made to a data mining pylon.

The Load command button 508 is used to load a file containing identification and configuration information pertaining to a data mining pylon.

The Save command button 510 is used to save the identification and configuration information for the current data mining pylon to a file.

The Exit command button 512 is used to close the GUI 500.

The Browse command button is used to browse the files available to the client 302 to search for a particular file.

The Save File text box 514 permits a user to input a name for a new or existing save file for storing data pylon information. The Save File text box 514 may be used in conjunction with the Save command button 510 to create a new save file for a data pylon. Alternately, by typing an existing save file name into the Save File text box 514 and clicking on the Load command box 508, the user may recall the save file for an existing data pylon, which will be displayed by the GUI 500.

The ObjectName text box 518 is used to input a name for a new or existing data pylon.

The X, Y and Z Position text boxes 520 are used to input the position at which a data pylon will be placed in the 3D multi-user environment.

The Heading text box 522 is used to input the heading of a data pylon, which may vary between 180° and −181°.

The Pylon Turned On? text box 524 is used as a toggle to determine whether the data pylon is generating facts or not. In embodiments, inputting a 1 value in this text box will turn a pylon on and inputting a 0 value in this text box will turn a pylon off.

The Record Vehicles? text box 526 is used as a toggle to determine whether the data pylon will detect the presence of vehicles within the pylon when generating facts or not. In embodiments, inputting a 1 value in this text box will cause a pylon to detect the presence of vehicles within the pylon and inputting a 0 value in this text box will cause a pylon not to detect the presence of vehicles within the pylon.

The Record Tools? Text box 528 is used as a toggle to determine whether the data pylon will detect the presence of tools within the pylon when generating facts or not. In embodiments, inputting a 1 value in this text box will cause a pylon to detect the presence of tools within the pylon and inputting a 0 value in this text box will cause a pylon not to detect the presence of tools within the pylon.

The Poll Frequency text box 530 is used to set the polling frequency for the data pylon. As noted above, data pylons may be polled at predetermined intervals to generate facts. In embodiments, the polling frequency may be varied from every 0.5 seconds to every 3600 seconds.

The Shape list box 532 permits a user to select one of various shapes for a data pylon. In the example GUI 500, the user can select from a sphere-shaped pylon, a box-shaped pylon, or a cone-shaped pylon by selecting one of the text boxes within the Shape list box 532.

The Sphere Radius text box 534 is used to input the radius for a sphere-shaped data pylon.

The Box Width, Box Height, and Box Length text boxes 536 are used to input the width, height, and length for a box-shaped data pylon respectively.

The Cone Height and Cone Radius text boxes 538 are used to input the height and radius of a cone-shaped data pylon, respectively.

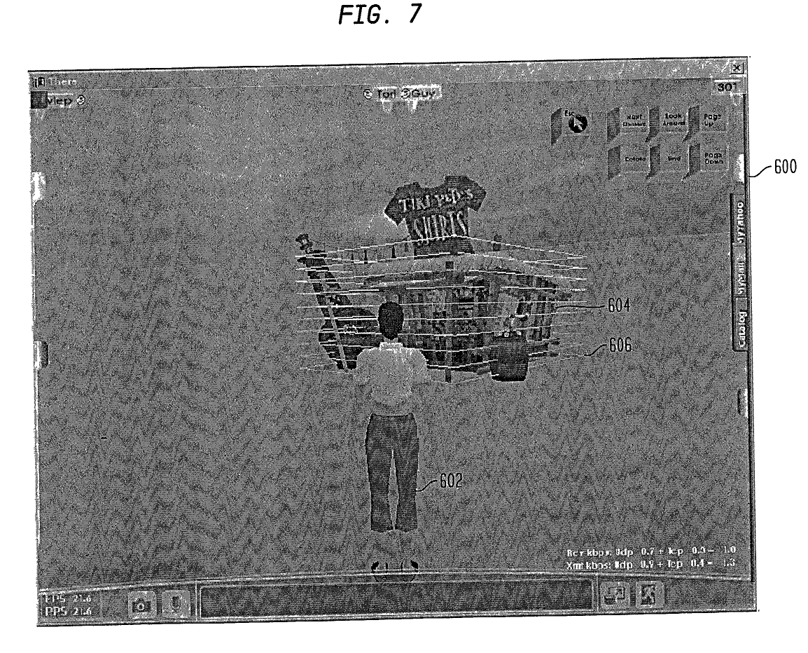

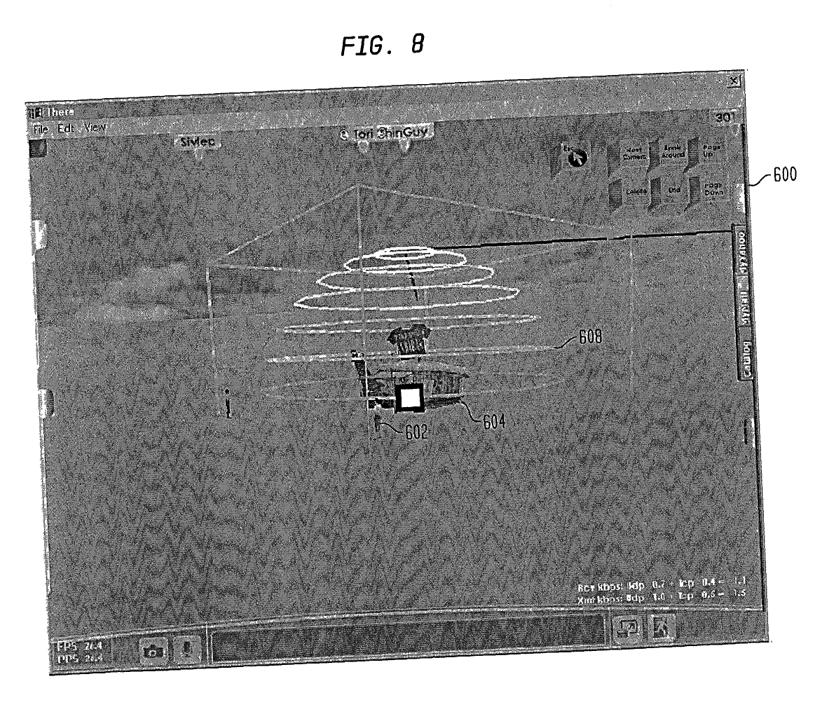

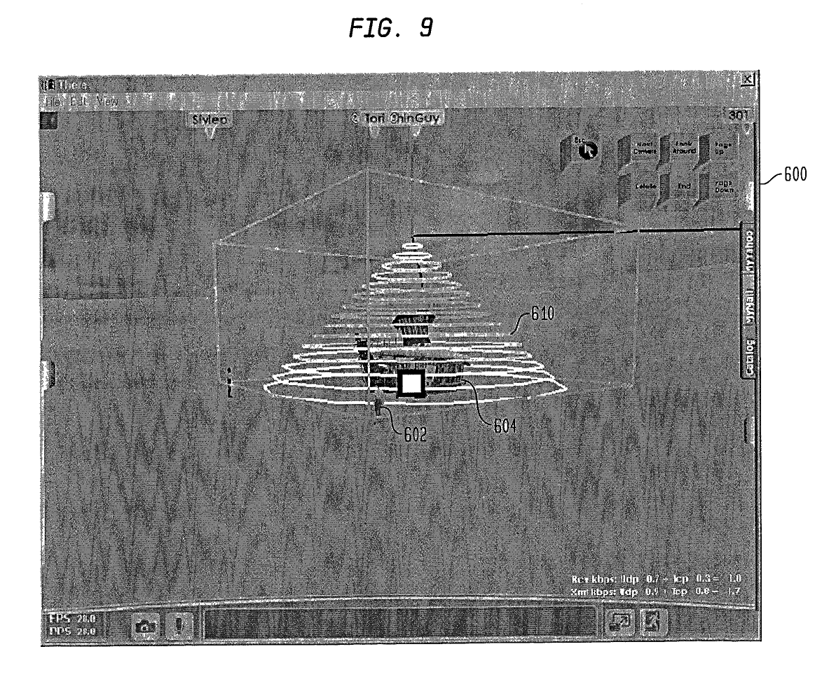

FIGS. 6-9 are screen shots of an “in-world” 3D GUI on the client 302 that actually show the placement of data mining pylons within the 3D multi-user environment. Each of FIGS. 6-9 depicts a 3D viewport 600 that provides a view of a 3D multi-user environment including a user avatar 602 and a virtual retail establishment 604. FIG. 7 shows that a box-shaped data mining pylon 606 has been placed around the virtual retail establishment 604. FIG. 8 shows that a sphere-shaped data mining pylon 608 has been placed around the virtual retail establishment 604. FIG. 9 shows that a cone-shaped data mining pylon 610 has been place around the virtual retail establishment 604.

ii. Capturing Pylon Data

In accordance with embodiments of the present invention, a data mining pylon may collect information in accordance with a variety of techniques including polling, polling snapshots, and entry and exit records.

Polling. According to a polling technique, a data mining pylon records and maintains a list of avatars and other distributed objects within it. At a configured polling time, a comparison is done between the current list and the last recorded list and any additions or deletions from the list are included and sent as data mining facts. Additions to the list represent the avatars that have entered the pylon. Deletions from the list represent avatars that have exited the pylon.

In most implementations, the amount of time required to perform this comparison will be proportional to the size of both lists multiplied together. Thus, where there are large numbers of objects within a given data pylon, the above-described polling technique can be computationally expensive, creating an adverse impact on system resources and possible degradation of the 3D simulation. However, the impact on system resources may be mitigated by a variety of factors.

For example, in embodiments of the present invention, the only data mining pylons that generate data mining facts are the server objects maintained on the Ihost servers. As a result, the resources of client machines are not at all impacted.

Furthermore, strategic placement of data mining pylons in areas where users are likely to congregate and remain for prolonged periods of time will permit a decrease in polling frequency without a concomitant loss of data mining information. Likewise, turning polling off for data mining pylons in inactive areas will conserve system resources.

The customization of pylons to fit only the objects or areas in which there is the most interest from a data mining perspective will avoid the collection of superfluous data and thereby conserve system resources. Data mining pylons can be adapted to conform to the shape of the objects that they are intended to cover. For example, square data mining pylons may be placed over buildings, domeshaped data mining pylons may be placed over a circular amphitheater, or a coneshaped data mining pylon may be placed over a tower.

A data mining pylon may also be programmed to dynamically change its properties based on a change in system resource level or based on the number of objects within it. For example, a pylon may be programmed to decrease its polling rate, shrink in size (as small as to its focal point), or split into two data mining pylons in response to reaching a certain critical level of system resources or in response to reaching a certain number of objects within it.

In embodiments of the present invention, the comparison of the current list of objects within a data mining pylon and the last-recorded list may be performed incrementally as necessary to maintain a minimum system resource level. For example, the comparison may be divided into small pieces wherein a portion of the work is done every time, t, such that the entire comparison is completed within the polling interval.

In further embodiments of the present invention, a dynamic polling frequency may be used to conserve system resources. In accordance with this technique, an ideal polling frequency is determined for a data mining pylon. When system resources have reached a critical level, the polling frequency for the data mining pylon may be decreased to save resources. When system processing capacity is restored to an acceptable level, the data mining pylon polling frequency can be raised to its ideal rate.

Polling Snapshots. According to a polling snapshot technique, a data mining pylon generates a fact corresponding to each avatar or other distributed object within it at a configured polling frequency. The outputs are not immediately compared as described in regard to the polling technique, above, but instead are individually stored to create full historical pictures of activities and events within the pylon space.

Entry/Exit Records. In accordance with an entry/exit records technique, a data mining fact is generated for an avatar or other distributed object whenever it enters or exits a data mining pylon. In embodiments, a counter records the duration of stay within the data mining pylon and this duration information is included with the data mining fact generated upon exit. This technique is similar to that of an object with usage trigger, as described above.

2. Data Mining on the AvMan Server

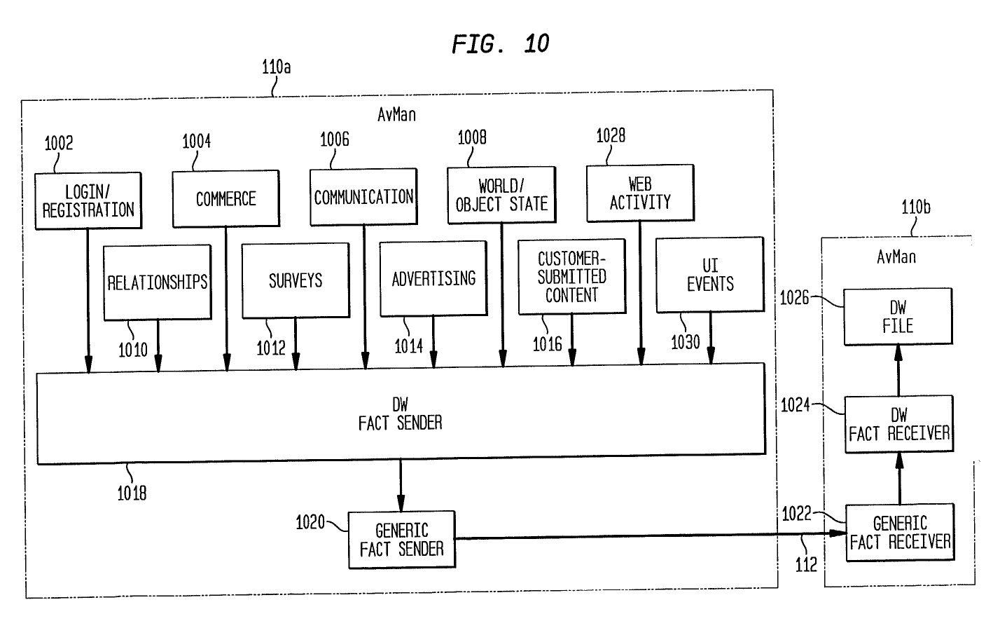

FIG. 10 presents a more detailed depiction of a first AvMan server 110a and a second AvMan server 110b within the server cluster 102 in accordance with an embodiment of the present invention. As discussed above in reference to FIG. 1, the AvMan servers 110a and 110b are operably interconnected via the network interface 112.

The AvMan server 110a includes a login/registration component 1002, a commerce component 1004, a communication component 1006, a world/object state component 1008, a relationships component 1010, a surveys component 1012, an advertising component 1014, a customer-submitted content component 1016, a Web activity component 1028, a user interface events component 1030, a DW factSender 1018, and a generic factSender 1020.

During the ongoing administration of the 3D multi-user environment by the AvMan 110a, the login/registration component 1002, commerce component 1004, communication component 1006, world/object state component 1008, relationships component 1010, surveys component 1012, advertising component 1014, customer-submitted content component 1016, Web activity component 1028, and user interface events component 1030, each generate facts that are received by the DW factSender 1018. A brief description of the type of facts generated by each of these components will now be described.

Login/Registration: The login/registration component 1002 administers the process by which users login and register to use the 3D multi-user environment. As such, this component can track such user information as password, login name, account number, user ID, avatar ID (if the user has more than one avatar), user name, and related user and avatar profile information. This information may be provided as facts to the DW factSender 1018. Data mining of this information permits information collected by any mechanism to be aggregated on the account level, user level, or avatar level.

Commerce: A 3D multi-user environment in accordance with embodiments of the present invention permits the sale, resale, trade and rental of distributed objects to users in exchange for on-line credits purchased by the user. Commercial transactions can also be executed between users in which credits are exchanged for distributed objects. The distributed objects may be created by a system administrator or user.

The commerce component 1004 manages the execution of these on-line commercial transactions, maintains an inventory of distributed objects that may be sold, resold, traded and rented, and tracks the amount of credits that each user possesses. The commerce component 1004 also tracks the creation and distribution of user-created objects, the pricing and repricing of traded objects, user inventories, discounts offered and received, and ownership history per object. Information concerning each commercial transaction, object and user inventories, user-created objects, pricing, distribution, ownership, and the amount of on-line credits possessed by each individual and in circulation in the virtual world may be provided as facts to the DW factSender 1018.

In embodiments of the 3D multi-user environment, the trial use of distributed objects by users prior to purchase is also permitted. Information concerning the execution of a free trial by a user may be provided as facts to the DW factSender 1018. This is in contrast to real retail stores, in which information of this type would not be available as no record is kept of trial use. For example, retail stores are typically unable to determine when a customer has tried on an article of clothing and then decided not to purchase it.

Communication: A 3D multi-user environment in accordance with embodiments of the present invention supports different modes of communication between users including e-mail, instant messaging, local chat and “emoticons,” which are chat messages that are accompanied by user-selected animation sequences and which may also contain additional text or audio content. The communication module 1006 manages the various modes of communication and can provide information about each message sent by a user including the type, format, content, sender and recipient(s) of each message to the DW factSender 1018 for data mining purposes.

World/Object State: The AvMan 110a tracks the state of the virtual 3D world including the state of the terrain, buildings, and landmarks. A snapshot of the state of the virtual 3D world or portions of the virtual 3D world may be generated at any time by the World/Object state component 1008 and submitted to the DW factSender 318. The AvMan 110a also includes a database that tracks the state of each of the distributed objects in the virtual 3D world. Object state may include such information as object identity, location, render and collision attributes, and physics attributes. A snapshot of the state of all or a portion of the distributed objects in the virtual 3D world may be generated at any time by the World/Object state component 1008 and submitted to the DW factSender 1018.

Relationships: In a 3D multi-user environment in accordance with embodiments of the present invention, a user may form relationships with other users through one or more system-defined designation processes. For example, a user may designate another user a “buddy” by adding that user to a “buddy” list. Additionally, a user may choose to ignore messages from another user by adding that user to an “ignore” list. In embodiments, users may also join formal groups with other users through a system-defined initiation process.

In further embodiments, relationship information may be generated by tracking certain behaviors of two or more users. For example, relationship information may be generated based on the amount of time two users spend together in the 3D virtual world, or based on their participation in common activities or events.

The relationships component 1010 of the AvMan server 110a tracks each user's relationship information and can provide that information as a fact to the DW factSender 1018. Relationship information is particularly significant for data mining as it permits the segmenting of markets based on social groups.

Surveys: In a 3D multi-user environment in accordance with embodiments of the present invention, the user can fill out on-line surveys related to a variety of topics. Surveys may include lengthy questionnaires or simple one-sentence questions requiring a response. The surveys component 1012 of the AvMan server 110a tracks this survey information and can provide it as facts to the DW factSender 1018.

Advertising: The advertising component 1014 tracks information about advertisements and distributed objects sponsored by advertisers in the 3D multi-user environment. The advertising component 1014 can provide information about advertisement opportunities, impressions, or views, as well as about actions initiated in response to an ad or sponsorship, as facts to the DW factSender 1018.

Customer-submitted Content: A 3D multi-user environment in accordance with embodiments of the present invention permits user to submit content that includes messages to message boards, news items, help requests, profile information, listing information, as well as user-created distributed objects. Information about customer-submitted content may be tracked and submitted as facts to the DW factSender 1018 by the customer-submitted content component 1016.

Web Activity. A 3D multi-user environment in accordance with embodiments of the present invention includes one or more interfaces through which a user may navigate the Internet and interact on Internet Web sites while simultaneously participating in the 3D virtual world. The Web activity component 1028 can compile data mining facts about the users activities on a Web site and provide the facts to the DW factSender 1018.

User Interface Events. The user interface events component 1030 can track information about a user's use or non-use of various features of the user interface. Such information may be utilized, for example, to determine from the user's perspective which aspects of the interface are considered desirable or which aspects of the interface need to be modified. The user interface events component 1030 can provide such information as facts to the DW factSender 1018.

The DW factSender 1018 formats and sends the facts received from the login/registration component 1002, the commerce component 1004, the communication component 1006, the world/object state component 1008, the relationships component 1010, the surveys component 1012, the advertising component 1014, the customer-submitted content component 1016, the Web activity component 1028, and the user interface events component 1030 to the generic factSender 1020, which receives the facts as well as other facts generated within the AvMan server 110a. The generic factSender 1020 then formats and sends all of the facts to the AvMan server 110b. In an embodiment, the generic factSender 1020 sends the facts to the AvMan server 110b as UDP packets using a UDP/IP protocol.

The AvMan server 110b includes a generic factReceiver 1022, a DW factReceiver 1024, and a data warehousing file 1026. The generic factReceiver 1022 receives the facts sent from the generic factSender 1020 on the AvMan server 110a. The DW factReceiver 1024 registers with the generic factReceiver 1022 to selectively receive the facts in which it is interested for data warehousing purposes from the larger pool of facts received by the generic factReceiver 1022. The DW factReceiver 1024 then reformats the selected facts for placement in the data warehousing file 1026.

In embodiments, all of the components shown in AvMan server 110a and AvMan server 110b exist on a single AvMan server, and the above-described data mining and warehousing steps remain the same, except that facts are not transferred from the generic factSender 1020 to the generic factReceiver 1022 over the network interface 112 but instead over a bus internal to the AvMan server. In further alternate embodiments, the AvMan server 110a and the AvMan server 110b are different servers in the same server cluster 102 or different servers in different server clusters. The arrangement of AvMan servers may depend on which arrangment is more efficient from a data collection and management point of view.

D. Data Warehousing in Accordance with Embodiments of the Present Invention

As discussed above, in embodiments of the present invention, data mining facts are generated by components on the Ihost servers 108a-108n, including data mining pylons and objects with usage triggers, and components on the AvMan servers 110a-110n, including components relating to login/registration, commerce, communication, world/object state, relationships, surveys, advertising, customer-submitted content, Web activity, and user interface events. These data mining facts are ultimately accumulated in one or more DW (data warehousing) files on one or more AvMan servers. For example, as shown in FIGS. 2 and 10, data mining facts are ultimately delivered to a DW file 214 and DW file 1026, respectively. In embodiments, individual DW files on the AvMan servers may be merged into a single DW file for the entire system.

In embodiments of the present invention, data mining facts are generated using common fields that permit the linking of data mining facts from different system components in the DW file. For example, whenever possible, data mining facts will include a user's account number, user ID, or avatar ID. The three forms of customer identification are mapped internally, allowing all relationships to be retained. This permits a user's activity in the 3D world (as tracked, for example, by a data pylon or object with usage trigger) to be linked to other information about that user, such as the user's profile information provided during registration, the user's commercial activity in the 3D world, or the user's communication and relationships with other users.

Furthermore, the data mining of certain key user fields, such as a user's account or other profile information, will permit the linking of data mining information from the DW file to external data mining information generated by other real-world systems and commercial entities. Thus, a larger customer picture may be created based on both internal and external data.

In further embodiments of the present invention, data mining facts are generated using fields that permit facts to be organized or aggregated in a hierarchical manner. For example, data mining facts about a user may organized or aggregated at an account level, a user level, or an avatar level. Similarly, data mining information pertaining to distributed objects may be organized or aggregated according to broad object categories (e.g., buildings or vehicles) or according to more narrow object descriptions (e.g., two-story homes or red skateboards).

In still further embodiments of the present invention, data mining facts are generated using fields that permit facts to be organized and analyzed based on certain criteria. For example, data mining facts may be generated with a time stamp or with the 3D coordinates of an object or event to which the fact pertains so that a time-based or location-based organization or analysis of the facts may be performed, respectively. Furthermore, data mining facts may be generated with an identification of the server that generated the fact so that a server-based organization or analysis may be performed. A server-based organization and analysis of facts may be useful for monitoring server loads and predicting system performance.

Ultimately, warehoused data mining facts may be used to discover, predict and confirm trends in customer behavior. For example, trends dealing with methods of customer acquisition, user conversion, segmentation, behavior, usage, visitation frequency, needs, desires, expectations, and relationships may be discovered, predicted, and/or confirmed. Also, warehoused data mining facts may be used to evaluate the popularity of various features within a 3D multi-user environment.

E. Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A data mining system for tracking user behavior in a three-dimensional multi-user environment, comprising:
an Ihost server, wherein said Ihost server is adapted to simulate the three-dimensional multi-user environment and objects therein; and
a plurality of clients connected to said Ihost server via a network, wherein each of said clients is adapted to allow a user to alter the location of said objects in the three-dimensional multi-user environment;
wherein said Ihost server is further adapted to maintain a data mining pylon in the three-dimensional multi-user environment, and wherein said data mining pylon is adapted to generate a data mining fact concerning the location of said objects in the three-dimensional multi-user environment.

2. The data mining system of claim 1, wherein said data mining pylon is further adapted to generate a list of objects within said data mining pylon at a predetermined point in time, and wherein said data mining fact generated by said data mining pylon includes said list of objects.

3. The data mining system of claim 2, wherein said data mining fact generated by said data mining pylon further includes state information for each of said objects included on said list of objects.

4. The data mining system of claim 1, wherein said data mining pylon is further adapted to generate a first list of objects within said data mining pylon at a first point in time, to generate a second list of objects within said data mining pylon at a second point in time, to compare said first list of objects to said second list of objects, wherein said objects appearing in said second list but not in said first list comprise objects that have entered said data mining pylon and said objects appearing in said first list but not in said second list comprise objects that have exited said data mining pylon, and wherein said data mining fact generated by said data mining pylon includes a list of said objects that have entered said data mining pylon and said objects that have exited said data mining pylon.

5. The data mining system of claim 1, wherein said data mining pylon is further adapted to identify an object that enters or exits said data mining pylon, and wherein said data mining fact generated by said data mining pylon includes an identification of said object that has entered or exited said data mining pylon.

6. The data mining system of claim 1, wherein said data mining pylon is invisible.

7. The data mining system of claim 1, wherein said data mining pylon contains a second data mining pylon, and wherein second data mining pylon is also adapted to generate a data mining fact concerning the location of said objects in the three-dimensional multi-user environment.

8. The data mining system of claim 1, wherein said data mining pylon is attached to an object in the three-dimensional multi-user environment, and wherein said object is a moving object.

9. The data mining system of claim 1, further comprising:
an AvMan server connected to said Ihost server, wherein said AvMan server comprises a data warehousing file;
wherein said Ihost server is further adapted to provide said data mining fact to said AvMan server and wherein said AvMan server is adapted to receive said data mining fact and to store said data mining fact in said data warehousing file.

10. The data mining system of claim 9, wherein said AvMan server is further adapted to generate a second data mining fact and to store said second data mining fact in said data warehousing file, and wherein said second data mining fact includes at least one of the following types of information:
user login information;
user registration information;
commerce information;
communication information;
world state information;
object state information;
user relationship information;
survey information;
advertising information;
customer-submitted content information;
Web activity information; or
user interface events information.

11. The data mining system of claim 1, wherein one of said plurality of clients further comprises:
an editor;
wherein said editor is adapted to allow a user to create a data mining pylon and change the state of said data mining pylon in the three-dimensional multi-user environment.

12. The data mining system of claim 1 1, wherein said editor is adapted to allow a user to change the state of said data mining pylon from visible to invisible and from invisible to visible.

13. The data mining system of claim 1, wherein said data mining pylon comprises a box, sphere, cylinder, or cone.

14. The data mining system of claim 1, wherein said objects comprise avatars.

15. The data mining system of claim 1, wherein said network comprises the Internet.

16. A data mining system for tracking user behavior in a three-dimensional multi-user environment, comprising:
an Ihost server adapted to simulate the three-dimensional multi-user environment and objects therein, wherein at least one of said objects comprises an object with usage trigger;
a plurality of clients connected to said Ihost server via a network, wherein each of said clients is adapted to allow a user to cause said objects to interact in the three-dimensional multi-user environment;
wherein said object with usage trigger is adapted to detect when a second object interacts with said object with usage trigger and to generate a data mining fact in response to said interaction.

17. The data mining system of claim 16, wherein said second object comprises an avatar.

18. The data mining system of claim 16, wherein said data mining fact comprises the identity of said object with usage trigger and said second object.

19. The data mining system of claim 16, wherein said data mining fact further comprises the type of interaction that has occurred, the time that said interaction occurred, and the location in the three-dimensional multi-user environment at which said interaction occurred.

20. The data mining system of claim 16, further comprising:
an AvMan server connected to said Ihost server, wherein said AvMan server comprises a data warehousing file;
wherein said Ihost server is further adapted to provide said data mining fact to said AvMan server and wherein said AvMan server is adapted to receive said data mining fact and to store said data mining fact in said data warehousing file.

21. The data mining system of claim 20, wherein said AvMan server is further adapted to generate a second data mining fact and to store said second data mining fact in said data warehousing file, and wherein said second data mining fact includes at least one of the following types of information:
user login information;
user registration information;
commerce information;
communication information;
world state information;
object state information;
user relationship information;
survey information;
advertising information;
customer-submitted content information;
Web activity information; or
user interface events information.

22. A method for data mining in a three-dimensional multi-user environment comprising:
simulating the three-dimensional multi-user environment and objects therein;
altering the location of said objects in the three-dimensional multi-user environment;
maintaining a data mining pylon in the three-dimensional multi-user environment; and
generating a data mining fact from said data mining pylon concerning the location of objects in the three-dimensional multi-user environment.

23. The method of claim 22, wherein generating a data mining fact comprises:
generating a list of objects within said data mining pylon at a predetermined point in time; and
generating a data mining fact comprising said list of objects.

24. The method of claim 22, wherein generating a data mining fact comprises:
generating a list of objects within said data mining pylon at a predetermined point in time; and
generating a data mining fact comprising said list of objects and state information for each of said objects included on said list of objects.

25. The method of claim 22, wherein generating a data mining fact comprises:
generating a first list of objects within said data mining pylon at a first point in time;
generating a second list of objects within said data mining pylon at a second point in time;
comparing said first list of objects to said second list of objects, wherein said objects appearing in said second list but not in said first list comprise objects that have entered said data mining pylon and said objects appearing in said first list but not in said second list comprise objects that have exited said data mining pylon; and
generating a data mining fact comprising a list of said objects that have entered said data mining pylon and said objects that have exited said data mining pylon.

26. The method of claim 22, wherein generating a data mining fact comprises:
identifying an object that enters or exits said data mining pylon; and
generating a data mining fact including an identification of said object that entered or exited said data mining pylon.

27. The method of claim 22, wherein maintaining a data mining pylon in the three-dimensional multi-user environment comprises maintaining said data mining pylon as an invisible object.

28. The method of claim 22, further comprising:
maintaining a second data mining pylon within said data mining pylon; and
generating a second data mining fact from said second data mining pylon concerning the location of objects in the three-dimensional multi-user environment.

29. The method of claim 22, further comprising:
attaching said data mining pylon to an object in the three-dimensional multi-user environment, wherein said object is a moving object.

30. The method of claim 22, further comprising:
storing said data mining fact in a data warehousing file.

31. The method of claim 30, further comprising:
generating a second data mining fact and storing said second data mining fact in said data warehousing file, wherein said data mining fact includes at least one of the following types of information:
user login information;
user registration information;
commerce information;
communication information;
world state information;
object state information;
user relationship information;
survey information;
advertising information;
customer-submitted content information;
Web activity information; or
user interface events information.

32. The method of claim 22, further comprising:
creating said data mining pylon in the three-dimensional multi-user environment.

33. The method of claim 32, further comprising:
changing the state of said data mining pylon from visible to invisible or from invisible to visible.

34. The method of claim 22, wherein said data mining pylon comprises a box, sphere, cylinder or cone.

35. The method of claim 22, wherein said objects comprise avatars.

36. The method of claim 22, wherein said network comprises the Internet.

37. A method for data mining in a three-dimensional multi-user environment comprising:
simulating the three-dimensional multi-user environment and objects therein, wherein at least one of said objects comprises an object with usage trigger;
causing said objects to interact in the three-dimensional multi-user environment;
detecting when a second object interacts with said object with usage trigger; and
generating a data mining fact in response to detecting said interaction.

38. The method of claim 37, wherein said second object comprises an avatar, and detecting when a second object interacts with said object with usage trigger comprises detecting when said avatar interacts with said object with usage trigger.

39. The method of claim 37, wherein generating a data mining fact comprises generating a data mining fact comprising the identity of said object with usage trigger and said second object.

40. The method of claim 37, wherein generating a data mining fact comprises generating a datamining fact comprising the identity of said object with usage trigger and said second object, the type of interaction that has occurred, the time that said interaction occurred, and the location in the three-dimensional multi-user environment at which said interaction occurred.

41. The method of claim 37, further comprising:
storing said data mining fact in said data warehousing file.

42. The method of claim 41, further comprising generating a second data mining fact and storing said second data mining fact in said data warehousing file, wherein said second data mining fact includes at least one of the following types of information:
user login information;
user registration information;
commerce information;
communication information;
world state information;
object state information;
user relationship information;
survey information;
advertising information;
customer-submitted content information;
Web activity information; or
user interface events information.

43. A computer program product comprising a computer useable medium having computer program logic recorded thereon for enabling a processor in a computer system to perform data mining in a three-dimensional multi-user environment, said computer program logic comprising:
means for enabling the processor to simulate the three-dimensional multi-user environment and objects therein;
means for enabling the processor to alter the location of said objects in the three-dimensional multi-user environment;
means for enabling the processor to maintain a data mining pylon in the three-dimensional multi-user environment; and
means for enabling the processor to generate a data mining fact from said data mining pylon concerning the location of objects in the three-dimensional multi-user environment.

44. A computer program product comprising a computer useable medium having computer program logic recorded thereon for enabling a processor in a computer system to perform data mining in a three-dimensional multi-user environment, said computer program logic comprising:
means for enabling the processor to simulate the three-dimensional multi-user environment and objects therein, wherein at least one of said objects comprises an object with usage trigger;
means for enabling the processor to cause said objects to interact in the three-dimensional multi-user environment;
means for enabling the processor to detect when a second object interacts with said object with usage trigger; and
means for enabling the processor to generate a data mining fact in response to detecting said interaction.
